(19) United States
(12) Patent Application Publication
(10) Pub. No.: US 2005/0288410 A1
(43) Pub. Date: Dec. 29, 2005

(54) Copolymer functionalized with an iodine atom, composition comprising it and treatment process

(76) Inventor: Céline Farcet, Paris (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/152,338

(22) Filed: Jun. 15, 2005

Related U.S. Application Data
(60) Provisional application No. 60/586,246, filed on Jul. 9, 2004.

(30) Foreign Application Priority Data
Jun. 15, 2004 (FR) 0451181

(51) Int. Cl. C08F 130/08

(52) U.S. Cl. 524/322; 526/279; 526/317.1; 526/319; 526/303.1; 526/346; 524/356; 524/379; 524/386

(57) ABSTRACT

The present disclosure relates to novel copolymers functionalized with an iodine atom, and comprising at least two different monomers chosen from monomers of (meth)acrylic type. The disclosure also relates to a cosmetic or dermatological composition comprising, in a physiologically acceptable medium, at least one copolymer functionalized with an iodine atom and comprising at least two different monomers chosen from (meth)acrylic monomers. The disclosure also relates to a cosmetic process for making up or caring for keratin materials using the composition.

This application claims benefit of U.S. Provisional Application No. 60/586,246, filed Jul. 9, 2004, the contents of which are incorporated herein by reference. This application also claims benefit of priority under 35 U.S.C. § 119 to French Patent Application No. 04 51181, filed Jun. 15, 2004, the contents of which are also incorporated by reference.

The present disclosure relates to novel copolymers and to compositions, such as cosmetic, pharmaceutical or dermatological topical compositions, comprising these copolymers.

In the field of cosmetics, compositions for obtaining a deposit, such as an adhesive or film-forming deposit, on keratin materials, such as the hair, the skin, the eyelashes or the nails, are often sought. For example, these compositions may provide color (i.e., in makeup or hair coloring compositions), sheen or a matte effect (i.e., in skincare or skin makeup compositions), physical properties such as shaping (i.e., in hair compositions, such as styling compositions), and protective or care properties (i.e., in care compositions, for example moisturizing or anti-UV compositions). Good remanance and good staying power of the cosmetic deposit over time are generally sought, and also good adhesion to the support. Such deposits should be able, generally, to withstand mechanical attack such as rubbing or transfer on contact with another object; water, sweat, tears, rain, sebum and oils. This is particularly important for makeup, such as lipsticks, where prolonged staying power of color and gloss, and transfer resistance of color are sought; and such as foundations, eye shadows and face powders, where staying power of the color supplied by the composition is sought, while simultaneously maintaining the transfer resistance and also the matte effect exhibited by the initial shade for as long as possible, despite the secretion of sebum and sweat by the wearer. In addition, makeup compositions that are comfortable to wear and do not have an excessively tacky texture are desired.

The above recited properties often conflict with one another. To achieve a composition that reconciles these properties within the same composition, a mixture of several different polymers, of different chemical nature, is generally used, with each polymer providing at least one of the desired characteristics. However, the polymers, having different chemical natures, within such a mixture are not necessarily compatible with one another. This may result in the polymer mixture exhibiting demixing problem within the composition.

The use of random polymers, for example, conventional acrylic polymers obtained by standard free-radical polymerization via random mixing of monomers, to a composition containing a mixture of polymers, in an attempt to solve the demixing problem, is known. However, these random polymers are known to exhibit dispersity in the polymer chains of the composition, which also leads to demixing. Thus, the addition of these random polymers may not solve this problem satisfactorily

In addition, the process of atom transfer radical polymerization (ATRP) is known and described, for example, in U.S. Pat. No. 5,807,937. ATRP allows the preparation of certain polymers that may be functionalized at their end, for example, with a bromine or chlorine atom. However, this process requires the use of metal catalysts, trace amounts of which may remain in the polymers thus prepared. If these polymers are used for cosmetic applications, the presence of trace amounts of Br or Cl in the polymer may pose a problem. In addition, Br and Cl atoms are not always labile enough to be easily replaced with more desired functions.

Further, polymers that are functionalized at their end and are obtained by degenerative transfer (DT) are known and described in International Application No. WO 99/20659. Free-radical polymerization controlled via DT allows the synthesis of functionalized (co)polymers of controlled molar mass and architecture. However, most polymers that have been prepared via this technique are homopolymers.

To overcome at least one of the drawbacks of the prior art, therefore, the present disclosure, therefore, proposes novel, cosmetically acceptable copolymers that are functionalized on at least one of their ends with an atom that is labile enough to be readily replaced.

Further, copolymers of the present disclosure may avoid the prior art problems of demixing within the formula while at the same time providing desired cosmetic properties.

One aspect of the present disclosure relates to a copolymer functionalized on at least one of its ends with an iodine atom, and comprising at least two different monomers chosen from the (meth)acrylic monomers defined below.

Another aspect of the present disclosure is a copolymer that may be obtained via free-radical polymerization controlled by degenerative transfer at the iodine atom:
of a free-radical initiator,
of a transfer agent comprising at least one iodine atom, and
of at least two different monomers chosen from the (meth)acrylic monomers defined below.

Another aspect of the present disclosure is a cosmetic or dermatological composition comprising, in a physiologically acceptable medium, at least one copolymer as defined above.

Copolymers according to the present disclosure may be easy to use in organic cosmetic media, such as solvent-based media and/or cosmetic oil media, while at the same time retaining advantageous Theological properties.

Further, the copolymers according to the disclosure exhibit good liposolubility in cosmetic solvents and/or cosmetic oils.

The term “soluble polymer,” as used herein, means that the polymer does not form a precipitate in the solvent. In one embodiment of the present disclosure, the copolymer according to the present disclosure may be soluble at a concentration of at least 1% by weight in isododecane at 25° C. and 1 atm, such as, for example, at a concentration of at least 5% by weight, or at least 10% by weight.

The copolymers of the present disclosure may be in various forms, such as in the form of a block or gradient polymer. In a particular embodiment, the copolymer of the present disclosure is in the form of a gradient polymer. As a result, the copolymer may be utilized in high concentrations in the cosmetic compositions of the disclosure.

In a gradient copolymer, the composition within the polymer chain follows a composition gradient. In at least one embodiment, the gradient copolymer has a low composition polydispersity, meaning that all of the copolymer chains have an approximately analogous composition (i.e., sequence of monomers) and are therefore of homogeneous composition. As a result, the copolymer chains are mutually compatible and the cosmetic compositions comprising these copolymers do not have the drawbacks and limitations of the compositions of the prior art.

When the presently disclosed copolymer is a linear gradient copolymer, it is represented by the formula:
F-[M₁M₂]_{gradient}-I

in which

F represents a residue derived from the transfer agent (the radical R defined below) or from the initiator;

I is an iodine atom; and

M₁ and M₂ are monomers or a mixture of monomers.

The copolymers according to the present disclosure may also be in block polymer form. For example, the polymers of the present disclosure may be in the form of a polymer comprising at least two different successive blocks, such as two successive blocks of different chemical nature. Each block of the copolymer according to the disclosure may be derived from one or more types of monomer. Therefore each block may consist of a homopolymer or a copolymer. If a block is a copolymer, this copolymer maybe a random, alternating or gradient copolymer. As a result, the monomer distribution within each block may be random or controlled, depending on the nature and/or reactivity of the monomers.

If the copolymer of the present disclosure is a block copolymer, it may be a diblock polymer of the AB type; or a triblock polymer, i.e. of the type ABA, BAB or ABC, wherein C is different from A and B; or multiblock polymers containing more than three blocks, i.e. of the type (AB)n, (ABA)n, (BAB)n, (ABC)n or ABCD, wherein A, B, C and D are of different chemical nature. In one embodiment of the present disclosure, the copolymer comprises at least 2 or 3 successive blocks, wherein the two successive blocks are different. For example, the copolymer may be of the AB, ABA or ABC type.

When the copolymer according to the present disclosure is a linear block copolymer, it may be represented schematically by the following formula: F-[(M₁)ₙ-(M₂)ₘ]-I, in which n and m are integers greater than 1.

The copolymers according to the disclosure may also be in the form of a star polymer, wherein each branch of the star may be in gradient or block form. Star polymers are obtained when the transfer agent utilized is polyfunctional and includes at least three iodine atoms.

If the copolymer is a a star copolymer, it may be represented by the formula F-[M₁M₂-I]_{n′}, wherein: M₁ and M₂ are different and represent a single monomer or a monomer mixture, and are arranged in a gradient (F-[(M₁M₂)_{grad}-I]_{n′}) or block (F-[(M₁)ₙ(M₂)ₘ-I]_{n′}) form; and n′ represents the number of branches in the star, and is an integer greater than 2, such as from 3 to 8.

If n′ is equal to 2, the polymer obtained is linear and difunctional.

The copolymer according to the present disclosure may also be a grafted copolymer, the skeleton of which may be in gradient or block form. Grafted polymers may be obtained when one or more of the monomers M1 and/or M2 is a macromonomer as defined below.

In one aspect of the present disclosure, the copolymers may be in block, gradient, linear-chain, grafted or star form.

In one embodiment, the copolymer is a linear, gradient or block copolymer.

The number-average molecular mass of the copolymer according to the present disclosure may be from 2000 g/mol to 1 000 000 g/mol, such as from 3000 g/mol to 500 000 g/mol, from 4000 g/mol to 200 000 g/mol, or from 5000 g/mol to 50 000 g/mol.

The number-average molecular mass (Mn) is determined via liquid gel permeation chromatography (GPC) using a THF eluent and a refractometric detector. Calibration is performed using linear polystyrene standards.

The copolymers of the present disclosure may be obtained by free-radical polymerization controlled by degenerative transfer at the iodine atom. For purposes of this disclosure, the term, “controlled free-radical polymerization” denotes polymerizations for which the side reactions that usually lead to the termination or transfer of the propagating species are rendered highly unlikely, relative to propagation reactions carried out by means of a free-radical control agent. However, when the concentration of free radicals become high relative to the monomer concentration, these side reactions become determining factors and generally result in a polymer having a broader mass distribution.

During controlled free-radical polymerization, the polymer chains of the gradient copolymers of the disclosure grow simultaneously, and thus incorporate the same ratio of comonomers over time. Therefore, all of the chains have the same or similar structure, resulting in low composition dispersity. Further, these chains also have a low mass polydispersity index. As mentioned above, gradient copolymers are copolymers having a concentration gradient of the various monomers along the chain. The distribution of the polymer chains of the comonomers depends on the relative concentrations of the comonomers during the synthesis. The gradient copolymers according to the disclosure comprise at least two different monomers, the concentration of which changes gradually along the polymer chain in both a systematic and predictable manner. Therefore, all of the polymer chains have at least one monomer Mi for which, irrespective of the normalized position x on the polymer chain, there is a non-zero probability of finding this same monomer along the chain. One of the defining characteristics of a gradient copolymer is the fact that at any instant in the polymerization, all of the chains are subjected to the presence of all of the monomers. Thus, in the reaction medium, the concentration of each monomer is always non-zero, at any instant in the polymerization.

This fact makes it possible to differentiate between gradient copolymers and block polymers in which the evolution of the monomers along the polymer chain is not systematic: for example, for a diblock copolymer AB, within the sequence A, the concentration of the monomer B is always zero.

In the case of random polymers, the concentration gradient of the monomers along the polymer chain will not be gradual, systematic and predictable.

Moreover, among gradient copolymers in general, copolymers-with a natural gradient and copolymers with an artificial gradient may be distinguished.

A copolymer with a natural gradient is a gradient copolymer batch-synthesized starting with an initial mixture of the co-monomers. The distribution in the chain of the various monomers follows a law deduced from the relative reactivity and the initial monomer concentrations. These copolymers constitute the simplest class of gradient copolymers, because the initial mixture defines the final property of the product.

A copolymer with an artificial gradient is a copolymer whose monomer concentration is varied during the synthesis. In this case, the relative concentration of monomers in the chain of the copolymer changes due to a sudden and abrupt change of the monomers and/or monomer concentration in the reaction medium. Further, one or more monomers may disappear, to the benefit of one or more others.

Moreover, in a gradient copolymer, the relative distribution of the compositions between the various chains of the copolymer is narrow. There is no overlap between the peak for the gradient copolymer and those for the respective homopolymers. This means that the material obtained by gradient consists of polymer chains having the same composition, whereas by standard random polymerization, various kinds of chain coexist, including those of the respective homopolymers.

Factors which impact the gradient include the relative reactivity coefficients of each monomer (known as rᵢ for the monomer Mi). These reactivity coefficients depend primarily on the type of synthetic process (homogeneous or dispersed) and solvents used. However, these coefficients are also impacted by the initial concentrations of each of the monomers, and by changes in monomer concentration, i.e. through the addition of monomers during the polymerization.

In a non-limiting embodiment of the present disclosure, the copolymers are prepared according to a degenerative transfer (DT) or degenerative iodine transfer (DIT) process. This process allows the formation of copolymers that are functionalized (i.e. mono- or multi-functionalized), on at least one of their ends, with an iodine atom. This process is described in International Patent Application No. WO 99/20659.

In the DT or DIT process, the chosen monomers are reacted with a polymerization initiator in the presence of an iodine-containing transfer agent.

The polymerization initiator may be any initiator known to those skilled in the art for its use in free-radical polymerization processes. Non-limiting examples of such initiators include azo type compounds, such as azobisisobutyronitrile; peroxide type compounds, such as organic hydroperoxides or peroxides containing 6-30 carbon atoms, for example benzoyl or didecanoyl peroxide; as well as redox couples, peresters, percarbonates or persulfates.

In a non-limiting embodiment of the present disclosure, the initiator is chosen from organic peroxides containing from 8 to 30 carbon atoms, such as the didecanoyl peroxide sold under the reference PERKADOX® SE-10 by the company Akzo Nobel.

Further non-limiting examples of initiators include 2,5-bis(2-ethylhexanoylperoxy)-2,5-dimethylhexane (TRIGONOX 141 from the company Akzo Nobel) and tert-butyl peroxy-2-ethylhexanoate (TRIGONOX 21S from the company Akzo Nobel).

The transfer agent may be represented by the formula R—I, in which R is a linear, branched or cyclic, saturated or unsaturated alkyl radical containing from 1 to 30 carbon atoms. R may optionally comprise 1 to 4 additional iodine atoms, one or more fluorine atoms, and/or one or more functional groups chosen from CN and COOH.

In a non-limiting embodiment of the present disclosure, R is chosen from alkyls containing 1 to 6 carbon atoms, and may comprise one or more halogen atoms, such as fluorine, and/or a CN function. For example, R may be a perfluoro C₁-C₆ alkyl or a C₁-C₆ alkyl bearing a CN function.

Non-limiting examples of transfer agents that may mentioned include iodo-1-perfluorohexane, iodoacetonitrile (ICH₂—CN), iodo-1-methane, diiodomethane, iodoform or triiodomethane, iodo-1-perfluoroisopropane, diiodoperfluorohexane, iodo-1-phenylethane, iodo-1-propane, iodo-1-isopropane, iodo-1-phenyl, 1,4-diiodophenyl and iodo-1-tert-butane.

Further, the transfer agent may be macromolecular and may be in the form of a polymer, homopolymer or copolymer, obtained via a prior step of degenerative iodine transfer polymerization, and thus functionalized with at least one iodine atom.

Transfer agents prepared by DIT may be used to prepare block copolymers.

The molar proportion r between the transfer agent and the initiator may range from 0.1 to 20, such as from 1 to 10, or from 2 to 5.

The molar proportion DP between the set of monomers and the transfer agent may be greater than 10, and may range from 50 to 1000, for example, from 100 to 500.

The copolymers of the present disclosure may be prepared by a person skilled in the art according to the following procedure:

1) A mixture of the various monomers is prepared, optionally in a solvent, preferably in a reactor, and is stirred. A free-radical polymerization initiator and a transfer agent are added. The mixture is preferably under an atmosphere of inert gas relative to a free-radical polymerization, such as nitrogen or argon.

The optional polymerization solvent may be chosen from cosmetic solvents and/or oils as defined below. For example, the polymerization solvent may be chosen from alkyl acetates such as butyl acetate or ethyl acetate, aromatic solvents such as toluene or alkanes such as isododecane, heptane or isohexadecane.

In general, a polymerization solvent in which the monomers and the resulting polymer are soluble is chosen.

2) The mixture is brought to the desired polymerization temperature and is stirred. The polymerization temperature may be within a range from 20° C. to 120° C., such as from 40° C. to 90° C.

The choice of the polymerization temperature may be optimized as a function of the chemical composition of the monomer mixture.

3) The polymerization medium is optionally modified during the polymerization, before reaching 90% conversion of the initial monomers, by supplemental addition of one or more monomers, such as the monomers of the initial mixture. This addition may be performed in various ways, including abrupt addition of a single portion of additional monomer(s), or via continuous addition of monomer(s) over the time period during which polymerization takes place.

4) The polymerization reaction is stopped when the desired degree of conversion is reached. The overall composition of the copolymer depends on the amount of conversion. In a non-limiting embodiment of the present disclosure, the polymerization is terminated after having reached at least 50% conversion. In other non-limiting embodiments, the polymerization reaction is terminated after reaching at least 60% or at least 90% conversion.

5) After the polymerization reaction is terminated, residual monomers which may remain can be removed by known methods, such as by evaporation, or by addition of an amount of standard polymerization initiator such as peroxide or azo derivatives.

6) If a block copolymer is desired, the additional monomer(s), and optionally the transfer agent and the initiator, may be added in an additional step, to form a second block.

The copolymer of the present disclosure may be obtained by free-radical polymerization either in bulk or in solution in an organic medium. The monomers may be added simultaneously, batchwise, semi-continuously or consecutively.

For batch polymerization, the optional solvent, the monomers and the initiator are mixed together in a reactor and heated to the required temperature.

For semi-continuous polymerization, all or some of the optional solvent, some of the monomers, such as from 1% to 20% by weight relative to the total weight of monomer, some of the initiator, such as from 1% to 20% by weight relative to the total weight of initiator, and optionally some of the transfer agent, such as from 0.1% to 20% by weight relative to the total weight of transfer agent, are introduced into a reactor and the mixture is heated to the required temperature. The remaining solvent of the monomers and the initiator is introduced by flow addition during the polymerization. The remaining constituents may then be introduced via identical or different, simultaneous or separate flow additions.

In a non-limiting embodiment of the present disclosure, a block copolymer may be formed by a process in which the first block is formed by polymerization of the first monomer or mixture of first monomers, after which the second monomer or mixture of monomers is added batchwise or semi-continuously.

In a non-limiting embodiment of the present disclosure, a copolymer having a composition gradient is prepared via a process where the monomers are introduced batchwise or semi-continuously. The polymerization of the first monomer, or mixture of first monomers, is started, and the second monomer, or mixture of second monomers, is added. simultaneously, batchwise, or semi-continuously, before the polymerization of the first monomer is complete.

The copolymer according to the present disclosure may comprise at least two different monomers chosen from the (meth)acrylic monomers described below, and also the salts thereof:
(i) (meth)acrylates of formula CH₂═CHCOOR or CH₂═C(CH₃)COOR wherein R is chosen from:
   linear or branched alkyl groups containing 1 to 30 carbon atoms optionally intercalated with at least one heteroatom chosen from O, N, S and P, and the alkyl group optionally substituted with one or more substituents chosen from —OH; halogen atoms chosen from Cl, Br, I and F; —NR₂R₃ groups, wherein R₂ and R₃, which may be identical or different, are chosen from hydrogen, linear and branched C₁ to C₆ alkyl group and a phenyl group; and polyoxyalkylene groups, such as, for example, polyoxyethylene and polyoxypropylene, wherein the polyoxyalkylene group consists of a repetition of from 5 to 30 oxyalkylene units;
   C₄ to C₁₂ cycloalkyl groups, wherein the cycloalkyl group optionally comprises in its chain one or more hetero atoms chosen from O, N, S and P, and which may be optionally substituted with one or more substituents chosen from —OH and halogen atoms chosen from Cl, Br, I and F;
   C₄ to C₂₀ aryl or C₅ to C₃₀ aralkyl groups, wherein the alkyl group of the aralkyl group contains from 1 to 8 carbon atoms;
   R may also comprise a methyl, ethyl, propyl, isopropyl, n-butyl, isobutyl, tert-butyl, hexyl, ethylhexyl, octyl, lauryl, isooctyl, isodecyl, dodecyl, cyclohexyl, t-butyl cyclohexyl, stearyl, ethyl-2-perfluorohexyl, 2-hydroxyethyl, 2-hydroxybutyl, 2-hydroxypropyl, methoxyethyl, ethoxyethyl, methoxypropyl, isobornyl, phenyl, 2-phenylethyl, t-butylbenzyl, benzyl, furfurylmethyl or tetrahydrofurfurylmethyl, methoxypolyoxyethylene (or POE-methyl) group; POE-behenyl, trifluoroethyl; dimethylaminoethyl, diethylaminoethyl, dimethylaminopropyl;
(ii) (meth)acrylamides of formula CH₂═CHCONR₄R₅ or CH₂═C(CH₃)CONR₄R₅ wherein R₄ and R₅, which may be identical or different, are chosen from
   a hydrogen atom and
   linear or branched alkyl groups containing from 1 to 18 carbon atoms, wherein the carbon atoms are optionally intercalated with at least one heteroatom chosen from O, N, S and P; the alkyl group optionally substituted with at least one substituent chosen from hydroxyl groups; halogen atoms chosen from Cl, Br, I and F; and groups Si(R₆R₇), wherein R₆ and R₇, which may-be identical or different, are chosen from C₁ to C₆ alkyl groups and phenyl groups;
   C₃ to C₁₂ cycloalkyl groups, such as, for example, an isobornyl group, or a heterocycloalkyl group (alkyl of 1 to 4 carbon atoms) such as furfurylmethyl or tetrahydrofurfurylmethyl;
   C₄ to C₂₀ aryl groups such as a phenyl group;
   C₅ to C₃₀ aralkyl groups, wherein the alkyl group of the aralkyl group contains from 1 to 8 carbon atoms, such as, for example, 2-phenylethyl and t-butylbenzyl;
   a methyl, ethyl, propyl, isopropyl, n-butyl, isobutyl, tert-butyl, hexyl, isohexyl, cyclohexyl, ethylhexyl, octyl, isooctyl, decyl, isodecyl, cyclodecyl, dodecyl, cyclododecyl, isononyl, lauryl, t-butylcyclohexyl, and stearyl group; 2-ethylperfluorohexyl; a C1-4 hydroxyalkyl group such as 2-hydroxyethyl, 2-hydroxybutyl and 2-hydroxypropyl; and a (C₁₋₄)alkoxy(C₁₋₄)alkyl group such as methoxyethyl, ethoxyethyl and methoxypropyl;
(iii) acrylic acid and methacrylic acid;
(iv) carbon-based macromonomers containing at least one (meth)acrylate polymerizable end group.

The copolymer may be any polymer, such as an oligomer, comprising on one of its ends a polymerizable (meth)acrylate end group capable of undergoing free-radical polymerization during the polymerization reaction with the monomers described above, to form the side chains of the polymer. The macromonomer may allow the side chains of the copolymer to be formed. Among additional macromonomers that may be used, non-limiting mention may be made of the following, alone or as a mixture, and also the salts thereof:
a) linear or branched C₈ to C₂₂ alkyl(meth)acrylate homopolymers and copolymers containing a (meth)acrylate polymerizable end group, among which non-limiting mention may be made of poly(2-ethylhexyl acrylate)macromonomers containing a mono(meth)acrylate end; poly(dodecyl acrylate) or poly(dodecyl methacrylate)macromonomers containing a mono(meth)acrylate end; poly(stearyl acrylate) or poly(stearyl methacrylate)macromonomers containing a mono(meth)acrylate end. Such macromonomers are described, for example, in European Patent Nos. EP 895 467 and EP 96 459.
b) polyolefins containing a (meth)acrylate end group, such as, for example, the following macromonomers: polyethylene macromonomers having a (meth)acrylate end group, polypropylene macromonomers having a (meth)acrylate end group, polyethylene/polypropylene copolymer macromonomers having a (meth)acrylate end group, polyethylene/polybutylene copolymer macromonomers having a (meth)acrylate end group, polyisobutylene macromonomers having a (meth)acrylate end group; polybutadiene macromonomers having a (meth)acrylate end group; polyisoprene macromonomers having a (meth)acrylate end group; polybutadiene macromonomers having a (meth)acrylate end group; poly(ethylene/butylene)-polyisoprene macromonomers having a (meth)acrylate end group. Such macromonomers are described, for example, in U.S. Pat. No. 5,626,005, which discloses ethylene/butylene and ethylene/propylene macromonomers containing a (meth)acrylate reactive end group. Further non-limiting mention may be made of poly(ethylene/butylene)methacrylate, such as, for example, the product sold under the name Kraton Liquid L-1253 by Kraton Polymers.

Among (meth)acrylic monomers, further non-limiting mention may be made of methyl, ethyl, n-propyl, isopropyl, butyl, isobutyl, cyclohexyl, cyclodecyl, stearyl, behenyl, isobornyl and 2-ethylhexyl(meth)acrylates; acrylic acid, methacrylic acid, N-ethyl(meth)acrylamide, N-butyl(meth)acrylamide, N-t-butyl(meth)acrylamide, N-isopropyl(meth)acrylamide, N,N-dimethyl(meth)acrylamide and N,N-dibutyl(meth)acrylamide; linear or branched C₈-C₂₂ alkyl(meth)acrylate homopolymers and copolymers containing a polymerizable (meth)acrylate end group; polyolefins containing a (meth)acrylate end group; and also the salts thereof; and mixtures thereof.

In one embodiment, the (meth)acrylic monomers may be chosen from isobornyl acrylate, isobornyl methacrylate, isobutyl acrylate, isobutyl methacrylate, 2-ethylhexyl acrylate, 2-ethylhexyl methacrylate, methyl acrylate, methyl methacrylate, stearyl acrylate, behenyl acrylate, acrylic acid and methacrylic acid; macromonomers of polyethylene/polypropylene copolymer and macromonomers of polyethylene/polybutylene copolymer, both containing a (meth)acrylate reactive end group.

The (meth)acrylic monomers as defined above may be present in an amount ranging from 30% to 100% by weight, such as, for example, from 50% to 98% by weight or from 70% to 95% by weight, relative to the total weight of monomers.

The copolymer according to the present disclosure may comprise a first monomer chosen from the (meth)acrylic monomers which may be present in an amount ranging from 1% to 99% by weight, such as, for example, 2-98% by weight, 5-95% by weight, or from 30% to 70% by weight, relative to the weight of the final copolymer, and a second monomer chosen from the (meth)acrylic monomers which is present in an amount ranging from 1% to 99% by weight, such as, for example, 2-98% by weight, 5-95% by weight,or from 15% to 85% by weight, relative to the weight of the final copolymer.

The copolymer according to the one embodiment of the present disclosure may comprise only two (meth)acrylic monomers, which may be present in a ratio that may range from 5/95 to 95/5, such as, for example, from 50/50 to 20/80, relative to each other. In another embodiment, the copolymer may comprise only two (meth)acrylic monomers present in a ratio of 30/70 relative to each other.

The copolymer according to another embodiment of the present disclosure may also comprise at least a third monomer, which may also be chosen from the (meth)acrylic monomers defined above, and which may be present in a proportion of from 1% to 50% by weight, such as, for example, from 3% to 40% by weight or 4% to 35% by weight, relative to the total weight of monomers.

The copolymer according to an embodiment of the present disclosure may also comprise one or more additional ethylenic monomers, which may not be (meth)acrylic monomers as defined above, and which may be present in an amount ranging from 0.1% to 70% by weight, such as, for example, from 2% to 50% by weight or from 5% to 30% by weight, relative to the total weight of the monomers.

In an embodiment of the present disclosure, additional monomers may be chosen, alone or as a mixture, from the following monomers, and also the salts thereof:
(i) ethylenically unsaturated monomers comprising at least one carboxylic, phosphoric or sulfonic acid or anhydride function, for instance crotonic acid, maleic anhydride, itaconic acid, fumaric acid, maleic acid, styrenesulfonic acid, vinylbenzoic acid, vinylphosphoric acid or acrylamidopropanesulfonic acid; and the salts thereof;
(ii) vinyl ethers of formula R₈O—CH═CH₂ or the vinyl esters of formula R₈—COO—CH═CH₂, wherein R₈ is chosen from a linear or branched alkyl group containing from 1 to 22 carbon atoms, a cyclic alkyl group containing from 3 to 6 carbon atoms and an aromatic group, such as, for example, benzene, anthracene or naphthalene;
(iii) vinyl compounds of formulae: CH₂═CH—R₉, CH₂═CH—CH₂—R₉ or CH₂═C(CH₃)—CH₂—R₉, wherein R₉ is chosen from
   a hydroxyl;
   halogens chosen from Cl and F;
   NH2;
   OR₁₀ groups, wherein R₁₀ is chosen from a phenyl group and a C₁ to C₁₂ alkyl group, wherein the monomer is a vinyl or allylic ether;
   acetamide (NHCOCH3);
   OCOR₁₁ groups, wherein R₁₁ is chosen from a linear or branched alkyl group of 2 to 12 carbons, wherein the monomer is a vinyl or allylic ester;
   linear or branched alkyl groups of 1 to 18 carbon atoms, wherein the carbon atoms are optionally intercalated with at least one heteroatom chosen from O, N, S and P; the alkyl group optionally substituted with at least one substituents chosen from hydroxyl groups; halogen atoms chosen from Cl, Br, I and F; and groups Si(R₁₂R₁₃), in which R₁₂ and R₁₃, which may be identical or different, are chosen from C₁ to C₆ alkyl groups and phenyl groups;
   C₃ to C₁₂ cycloalkyl groups, such as, for example, isobornyl or cyclohexane,
   C₃ to C₂₀ aryl groups, such as, for example, phenyl,
   C₄ to C₃₀ aralkyl groups, wherein the alkyl contains from 1 to 8 carbon atoms, such as, for example, 2-phenylethyl;
   4- to 12-membered heterocyclic groups containing one or more hetero atoms chosen from O, N and S, the ring being aromatic or non-aromatic,
   heterocycloalkyl groups containing from 1 to 4 carbon atoms, such as, for example, furfurylmethyl or tetrahydrofurfurylmethyl;
(iv) styrenes, such as, for example, methylstyrene, chlorostyrene or chloromethylstyrene;
(v) ethylenically unsaturated monomers comprising one or more silicon atoms, such as, for example, methacryloxypropyltrimethoxysilane or methacryloxypropyltris(trimethylsiloxy)silane.

Further non-limiting mention of additional ethylenic monomers that may also be used include carbon-based macromonomers containing at least one polymerizable end group other than (meth)acrylic, or silicone-based macromonomers containing at least one polymerizable end group. In one embodiment of the present disclosure, the end group may be an ethylenically unsaturated group capable of undergoing free-radical polymerization with the monomers constituting the skeleton. In another embodiment of the present disclosure, the macromonomer may form the side chains of the copolymer. In a further embodiment, the polymerizable group of the macromonomer may be an ethylenically unsaturated group capable of undergoing free-radical polymerization. The polymerizable end group may be, for example, a vinyl group other than (meth)acrylate for the carbon-based macromonomers, or alternatively a vinyl group, such as (meth)acrylate, for the silicone-based macromonomers. Among the additional macromonomers that may be used, non-limiting mention may be made of, alone or as a mixture, and also the salts thereof:
(i) linear or branched C₈-C₂₂ alkyl(meth)acrylate homopolymers and copolymers containing a polymerizable end group chosen from vinyl groups other than (meth)acrylate, among which non-limiting mention may be made of poly(2-ethylhexyl acrylate)macromonomers containing a vinyl end group; poly(dodecyl acrylate) or poly(dodecyl methacrylate)macromonomers containing a vinyl end group; poly(stearyl acrylate) or poly(stearyl methacrylate)macromonomers containing a vinyl end group. Such macromonomers are described, for example, in European Patent Nos. EP 895 467 and EP 96 459.
(ii) polyolefins containing an ethylenically unsaturated end group other than (meth)acrylate. Non-limiting mention may be made of the following macromonomers, it being understood that they contain a non-(meth)acrylate vinyl end group: polyethylene macromonomers, polypropylene macromonomers, macromonomers of polyethylene/polypropylene copolymer, macromonomers of polyethylene/polybutylene copolymer, polyisobutylene macromonomers; polybutadiene macromonomers; polyisoprene macromonomers; polybutadiene macromonomers; poly(ethylene/butylene)-polyisoprene macromonomers. Such macromonomers are described, for example, in U.S. Pat. No. 5,625,005.
(iii) polydimethylsiloxanes containing a mono(meth)acrylate end group, such as, for example, those of formula (I) below: 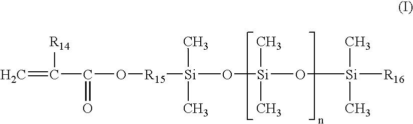
   wherein:
   R₁₄ is chosen from a hydrogen atom and methyl groups and in one embodiment is methyl;
   R₁₅ is chosen from linear and branched divalent hydrocarbon-based groups containing from 1 to 10 carbon atoms and optionally containing one or two ether bonds —O—, such as, for example, ethylene, propylene or butylene;
   R₁₆ is chosen from a linear and branched alkyl groups containing from 1 to 10 carbon atoms, such as, for example, from 2 to 8 carbon atoms, including methyl, ethyl, propyl, butyl or pentyl;
   n is chosen from an integer ranging from 1 to 300, such as, for example, ranging from 3 to 200 or ranging from 5 to 100.

Among silicone macromonomers that may be used according to the present disclosure, non-limiting mention may be made of monomethacryloyloxypropyl polydimethylsiloxanes such as those sold under the name PS560-K6 by UCT (United Chemical Technologies Inc.) or under the name MCR-M17 by Gelest Inc.

Among the additional ethylenic monomers that may be used according to the present disclosure, non-limiting mention may be made of ethylenically unsaturated monomers comprising one or more silicon atoms, such as methacryloxypropyltrimethoxysilane, methacryloxypropyltris(trimethylsiloxy)silane; styrene and its derivatives; linear or branched C₈ to C₂₂ alkyl(meth)acrylate homopolymers and copolymers containing a vinyl end group other than (meth)acrylate; polyolefins containing a vinyl end group other than (meth)acrylate, and polydimethylsiloxanes containing a mono(meth)acrylate end group, and those of formula (I) above.

Among the salts that may be used according to the present disclosure, non-limiting mention may be made of those obtained by neutralization of acid groups using mineral bases such as LiOH, NaOH, KOH, Ca(OH)₂, NH₄OH or Zn(OH)₂; or with an organic base such as a primary, secondary or tertiary alkylamine, including triethylamine or butylamine. This primary, secondary or tertiary alkylamine may comprise one or more nitrogen and/or oxygen atoms and may thus comprise, for example, one or more alcohol functions; mention may also be made of 2-amino-2-methylpropanol, triethanolamine and 2-dimethylaminopropanol. Non-limiting mention may also be made of lysine or 3-(dimethylamino)propylamine.

Non-limiting mention may also be made of the salts of mineral acids, such as, for example, sulfuric acid, hydrochloric acid, hydrobromic acid, hydroiodic acid, phosphoric acid or boric acid. Further non-limiting mention may be made of the salts of organic acids, which may comprise one or more carboxylic, sulfonic or phosphonic acid groups. They may be linear, branched or cyclic aliphatic acids, or alternatively aromatic acids. These acids may also comprise one or more heteroatoms chosen from O and N, such as, for example, heteroatoms in the form of hydroxyl groups. Non-limiting mention may also be made of propionic acid, acetic acid, terephthalic acid, citric acid and tartaric acid.

In another non-limiting embodiment of the disclosure, the copolymer comprises at least one monomer with a Tg of less than or equal to 20° C., i.e. from −150° C. to 20° C., from −130° C. to 18° C., or from −120° C. to 15° C., or a mixture of such monomers.

The at least one monomer having the Tg property disclosed above may be chosen from the soluble or insoluble monomers mentioned above.

The at least one monomer with a Tg≦20° C. may be present in the copolymer in an amount ranging from 1% to 99% by weight, such as from 10% to 90%, 20% to 80%, or 25% to 75% by weight, relative to the total weight of the copolymer.

In a non-limiting embodiment, the copolymer according to the disclosure further comprises at least one monomer with a Tg of greater than or equal to 20° C., i.e. from 25° C. to 150° C., from 30° C. to 145° C., or from 40° C. to 140° C., or a mixture of such monomers.

These monomers having a Tg of greater than or equal to 20° C., 25° C., 30° C., and 40° C. may be chosen from the soluble or insoluble monomers mentioned above.

The monomer(s) with a Tg≧20° C. may be present in an amount ranging from 1% to 99% by weight, i.e. from 10% to 90% by weight, from 20% to 80% by weight, or from 25% to 75% by weight, relative to the total weight of the copolymer.

For the purpose of the present disclosure, the term “monomer with a Tg” denotes monomers whose homopolymer has such a Tg. In the present disclosure, the Tg (glass transition temperature) values are theoretical Tg values determined from the theoretical Tg values of the constituent monomers of each of the blocks, which may be found in a reference manual such as the Polymer Handbook, 3^{rd} edition, 1989, John Wiley, according to the following relationship, known as Fox's law:

$$\frac{1}{Tg} = {\sum }_{i} ( \frac{wi}{Tgi} )$$

wherein wi is the mass fraction of the monomer i in the block under consideration and Tgi is the glass transition temperature of the homopolymer of the monomer i.

A person skilled in the art would know how to select the monomers and the amounts thereof as a function of the desired result, on the basis of his general knowledge, for example, of the relative reactivity of each monomer. For example, the type and amount of monomers and the solvent medium may be chosen so as to obtain a copolymer that is soluble in the said solvent medium.

In a non-limiting embodiment of the present disclosure, the copolymers of the present disclosure are soluble in lipophilic solvent media, such as the solvents (i.e. the lipophilic solvents) and/or the carbon-based oils conventionally used in cosmetics.

For the purposes of this disclosure, the term “soluble,” means that the polymer does not form a precipitate in a solvent in which it is contained. In a non-limiting embodiment of the present disclosure, the copolymer is soluble at a concentration of at least 1% by weight in isododecane at 25° C. and 1 atm.

The gradient copolymers of the present disclosure may be present in cosmetic, dermatological, or topical compositions in an amount ranging from 0.1% to 95% by weight, such as from 0.5% to 90%, from 1% to 80%, from 5% to 70%, or from 8% to 30% by weight, relative to the total weight of the composition.

The copolymers of the present disclosure may be present in the composition in dissolved form, for example in an organic solvent or a cosmetic carbon-based oil.

Non-limiting embodiments of the copolymers of the present disclosure may be soluble in cosmetic solvents, and may be used in organic cosmetic media, while at the same time retaining advantageous rheological properties.

The cosmetic or dermatological compositions of the present disclosure may further comprise, in addition to the aforementioned copolymers, a physiologically acceptable medium, such as a cosmetically or dermatologically acceptable medium (i.e. a medium that is compatible with keratin materials such as facial or body skin, the lips, the hair, the eyelashes, the eyebrows and the nails).

The composition of the present disclosure may further comprise a solvent medium, which may be a fatty phasethat may itself comprise oils and/or solvents that may be lipophilic, as well as fatty substances that are solid at room temperature, such as waxes, pasty fatty substances and gums, and mixtures thereof.

Among the constituents of the fatty phase, non-limiting mention may be made of oils and/or solvents having a global solubility parameter according to the Hansen solubility space of less than or equal to 20 (MPa)^{1/2}, less than or equal to 18 (MPa)^{1/2}, or less than or equal to 17 (MPa)^{1/2}.

The global solubility parameter δ according to the Hansen solubility space is defined in the article “Solubility parameter values” by Eric A. Grulke in the book “Polymer Handbook”, 3^{rd} edition, Chapter VII, pp. 519-559, by the relationship:
δ=(dD²+dP²+dH²)^{1/2}
in which
dD characterizes the London dispersion forces derived from the formation of dipoles induced during molecular impacts,
dP characterizes the Debye forces of interaction between permanent dipoles, and
dH characterizes the specific forces of interaction (such as hydrogen bonding, acid/base, donor/acceptor, etc.).

The definition of solvents in the Hansen solubility space is described in the article by C. M. Hansen “The three-dimensional solubility parameters”, J. Paint Technol. 39, 105 (1967).

Among the oils and/or solvents having a global solubility parameter according to the Hansen solubility space of less than or equal to 20 (MPa)^{1/2}, non-limiting mention may be made of branched or unbranched, volatile or non-volatile oils, which may be chosen from natural or synthetic oils, carbon-based oils, hydrocarbon-based oils, fluoro oils, and mixtures thereof; ethers and esters containing at least 6 carbon atoms, such as from C₆ to C₃₀ ethers and esters; ketones containing at least 6 carbon atoms, such as C₆ to C₃₀ ketones; C₆ to C₃₀ aliphatic fatty monoalcohols, the hydrocarbon-based chain of which does not comprise substitution groups.

For the purpose of the present disclosure, the term “non-volatile oil” means an oil that is capable of remaining on the skin at room temperature and atmospheric pressure for at least one hour, and which may have vapor pressure at room temperature (25° C.) and atmospheric pressure, of less than 0.01 mm Hg (1.33 Pa).

Of the aforementioned non-volatile oils, non-limiting mention may be made of carbon-based oils, including hydrocarbon-based non-volatile oils of plant, mineral, animal or synthetic origin, such as liquid paraffin (petroleum jelly), squalane, hydrogenated polyisobutylene (PARLEAM oil), perhydrosqualene, mink oil, macadamia oil, turtle oil, soybean oil, sweet almond oil, beauty-leaf oil, palm oil, grapeseed oil, sesame seed oil, corn oil, arara oil, rapeseed oil, sunflower oil, cottonseed oil, apricot oil, castor oil, avocado oil, jojoba oil, olive oil or cereal germ oil, and shea butter oil; linear, branched or cyclic esters containing more than 6 carbon atoms, for example C₆ to C₃₀ esters such as lanolic acid, oleic acid, lauric acid or stearic acid esters; esters derived from long-chain acids or alcohols (i.e. acids or alcohols containing from 6 to 20 carbon atoms), such as esters of formula RCOOR′, in which R represents a C₇-C₁₉ higher fatty acid residue and R′ represents a C₃-C₂₀ hydrocarbon-based chain, for example C₁₂-C₃₆ esters such as isopropyl myristate, isopropyl palmitate, butyl stearate, hexyl laurate, diisopropyl adipate, isononyl isononanoate, 2-ethylhexyl palmitate, 2-hexyldecyl laurate, 2-octyldecyl palmitate, 2-octyldodecyl myristate or lactate, bis(2-ethylhexyl)succinate, diisostearyl malate and glyceryl or diglyceryl triisostearate; higher fatty acids, including C₁₄-C₂₂ fatty acids such as myristic acid, palmitic acid, stearic acid, behenic acid, oleic acid, linoleic acid, linolenic acid or isostearic acid; higher fatty alcohols, such as C₁₆-C₂₂ higher fatty alcohols, such as cetanol, oleyl alcohol, linoleyl alcohol, linolenyl alcohol, isostearyl alcohol or octyldodecanol; and mixtures thereof.

Non-limiting mention may also be made of decanol, dodecanol, octadecanol, liquid triglycerides of C₄-C₁₀ fatty acids, such as heptanoic or octanoic acid triglycerides, and caprylic/capric acid triglycerides; linear or branched hydrocarbons of mineral or synthetic origin, such as liquid paraffins and derivatives thereof, petroleum jelly, polydecenes, and hydrogenated polyisobutene such as PARLEAM; synthetic esters and ethers, including those of fatty acids, such as PURCELLIN oil, isopropyl myristate, 2-ethylhexyl palmitate, 2-octyldodecyl stearate, 2-octyldodecyl erucate or isostearyl isostearate; hydroxylated esters, such as isostearyl lactate, octyl hydroxystearate, octyldodecyl hydroxystearate, diisostearyl malate, triisocetyl citrate, and fatty alcohol heptanoates, octanoates and decanoates; polyol esters, such as propylene glycol dioctanoate, neopentyl glycol diheptanoate or diethylene glycol diisononanoate; pentaerythritol esters; and C₁₂ to C₂₆ fatty alcohols, such as octyldodecanol, 2-butyloctanol, 2-hexyldecanol or 2-undecylpentadecanol.

Non-limiting mention may also be made of ketones that are liquid at room temperature, such as methyl ethyl ketone, methyl isobutyl ketone, diisobutyl ketone, isophorone, cyclohexanone or acetone; propylene glycol ethers that are liquid at room temperature, such as propylene glycol monomethyl ether, propylene glycol monomethyl ether acetate or dipropylene glycol mono-n-butyl ether; C₃-C₈ short-chain esters, such as ethyl acetate, methyl acetate, propyl acetate, n-butyl acetate or isopentyl acetate; ethers that are liquid at room temperature, such as diethyl ether, dimethyl ether or dichlorodiethyl ether; alkanes that are liquid at room temperature, such as decane, heptane, dodecane, isododecane, isohexadecane or cyclohexane; cyclic aromatic compounds that are liquid at room temperature, such as toluene and xylene; aldehydes that are liquid at room temperature, such as benzaldehyde and acetaldehyde; and mixtures thereof.

Among the volatile compounds, non-limiting mention may be made of non-silicone volatile oils, such as C₈ to C₁₆ Isoparaffins, including, for example, isododecane, isodecane, and isohexadecane and the oils sold under the trade names ISOPAR and PERMETHYL. In a non-limiting embodiment of the present disclosure, the volatile compound is the isododecane known as PERMETHYL 99A.

In addition, non-limiting mention may be made of volatile or non-volatile alkanes that are liquid at room temperature, such as decane, heptane, dodecane, isododecane, isohexadecane, cyclohexane and isodecane, and mixtures thereof.

These oils and/or solvents may be present in the composition in an amount ranging from 0.01% to 95%, such as, for example, from 0.1% to 90%, from 10% to 85%, or from 30% to 80% by weight, relative to the total weight of the composition.

The composition of the present disclosure may further comprise a hydrophilic medium comprising water or a mixture of water and of hydrophilic organic solvent(s). Non-limiting examples of suitable compounds that may be used in the hydrophilic medium include alcohols, such as linear or branched lower monoalcohols containing from 2 to 5 carbon atoms, such as, for example, ethanol, isopropanol or n-propanol; polyols, such as glycerol, diglycerol, propylene glycol, sorbitol, pentylene glycol and polyethylene glycols; hydrophilic C₂ ethers; and hydrophilic C₂-C₄ aldehydes.

The water or the mixture of water and of hydrophilic organic solvents may be present in the composition of the present disclosure in an amount ranging from 0.1% to 80% by weight, such as from 1% to 70% by weight, relative to the total weight of the composition.

The composition of the present disclosure may further comprise waxes and/or gums.

For the purposes of the present disclosure, the term “wax” means a lipophilic compound that is solid at room temperature (25° C.), can undergo a reversible solid/liquid phase change, and has a melting point ranging from 30° C. to 120° C. By bringing the wax to the liquid state (melting), the wax may become miscible with the oils that may be present in the composition, resulting in the formation of a microscopically homogeneous mixture. However, on returning the temperature of the mixture to room temperature, recrystallization of the wax in the oils of the mixture takes place. The melting point of the wax may be measured using a differential scanning calorimeter (DSC), such as the calorimeter sold under the name DSC 30 by the company Mettler.

Non-limiting examples of compounds which may be utilized as the aforementioned wax include hydrocarbon-based waxes, fluoro waxes and/or silicone waxes. These waxes may be of plant, mineral, animal and/or synthetic origin. The waxes may have a melting point of greater than 25° C., such as, for example, greater than 45° C. Of these waxes, non-limiting mention may be made of beeswax, carnauba wax, candelilla wax, paraffin, microcrystalline waxes, ceresin or ozokerite; synthetic waxes, such as polyethylene waxes or Fischer Tropsch waxes; and silicone waxes, such as C₁₆ to C₄₅ alkyl or alkoxy dimethicones.

Non-limiting examples of the aforementioned gums include polydimethylsiloxanes (PDMSs) of high molecular weight, cellulose gums, polysaccharides, and pasty substances that are generally hydrocarbon-based compounds, such as lanolins, derivatives thereof, or polydimethylsiloxanes.

The type and amount of the solid substances used in the present disclosure depend on the mechanical properties and textures desired. Non-limiting examples of the composition of the present disclosure may contain from 0.01% to 50% by weight, such as from 1% to 30% by weight, of the aforementioned waxes, relative to the total weight of the composition.

The composition of the present disclosure may further comprise one or more dyestuffs chosen from water-soluble dyes, liposoluble dyes and pulverulent dyestuffs, such as pigments, nacres and flakes that are known to those skilled in the art. These dyestuffs may be present in the composition in an amount ranging from 0.01% to 50% by weight, such as from 0.01% to 30% by weight, relative to the weight of the composition.

As used herein, the term “pigments” means white or colored, mineral or organic particles of any shape, which are insoluble in the physiological medium and are intended to color the composition. Further, the term “nacres” as used herein, means iridescent particles of any shape, which may be produced synthetically or by certain molluscs in their shell. The pigments may be white or colored, and may be mineral and/or organic. Among these mineral pigments, non-limiting mention may be made of titanium dioxide (which may be surface-treated), zirconium oxide, cerium oxide, zinc oxide, iron oxide (black, yellow or red), chromium oxide, manganese violet, ultramarine blue, chromium hydrate, ferric blue, and metal powders, such as aluminium or copper powder. Among the aforementioned organic pigments, non-limiting mention may be made of carbon black, pigments of D & C type, and lakes based on cochineal carmine or on barium, strontium, calcium or aluminium. Non-limiting examples of nacreous pigments that may be utilized include white nacreous pigments such as mica coated with titanium or bismuth oxychloride, colored nacreous pigments such as titanium mica coated with iron oxides, titanium mica coated with ferric blue or chromium oxide, titanium mica coated with an organic pigment disclosed above, and nacreous pigments based on bismuth oxychloride.

Among water-soluble dyes, non-limiting mention may be made of the disodium salt of ponceau, the disodium salt of alizarin green, quinoline yellow, the trisodium salt of amaranth, the disodium salt of tartrazine, the monosodium salt of rhodamine, the disodium salt of fuchsin, xanthophyll, and methylene blue.

The composition according to the disclosure may further comprise one or more fillers. Such fillers may be present in the composition in an amount ranging from 0.01% to 50% by weight, including from 0.01% to 30% by weight, relative to the total weight of the composition. As used herein, the term “fillers” means colorless or white, mineral or synthetic particles of any. shape, which are insoluble in the medium of the composition irrespective of the temperature at which the composition is manufactured. These fillers may serve to modify the rheology or texture of the composition. The fillers may be mineral or organic and of any shape, i.e. platelet-shaped, spherical or oblong, irrespective of the crystallographic form (for example lamellar, cubic, hexagonal, orthorhombic, etc.). Of these fillers, non-limiting mention may be made of talc, mica, silica, kaolin, polyamide (NYLON) powder (ORGASOL® from Atochem), poly-β-alanine powder, polyethylene powder, powders of tetrafluoroethylene polymers (TEFLON), lauroyllysine, starch, boron nitride, hollow polymer microspheres such as those of polyvinylidene chloride/acrylonitrile, for example EXPANCEL® (Nobel Industrie), acrylic acid copolymers (POLYTRAP from the company Dow Corning), silicone resin microbeads (for example TOSPEARLS® from Toshiba), elastomeric polyorganosiloxane particles, precipitated calcium carbonate, magnesium carbonate, magnesium hydrocarbonate, hydroxyapatite, hollow silica microspheres (SILICA BEADS® from Maprecos), glass or ceramic microcapsules, and metal soaps derived from organic carboxylic acids containing from 8 to 22 carbon atoms, such as from 12 to 18 carbon atoms, including, for example zinc, magnesium or lithium stearate, zinc laurate or magnesium myristate.

The composition may further comprise an additional polymer such as a film-forming polymer. According to the present disclosure, the term “film-forming polymer” means a polymer capable of forming, by itself or in the presence of an auxiliary film-forming agent, a continuous film that adheres to a support, such as keratin materials. Among the film-forming polymers that may be used in the composition of the present disclosure, non-limiting mention may be made of synthetic free-radical polymers, polycondensate polymers, and polymers of natural origin and mixtures thereof, including acrylic polymers, polyurethanes, polyesters, polyamides, polyureas and cellulose-based polymers such as nitrocellulose.

The composition according to the disclosure may further comprise additional ingredients that are commonly used in cosmetics, examples of which include, but are not limited to vitamins, thickeners, gelling agents, trace elements, softeners, sequestering agents, fragrances, acidifying or basifying agents, preserving agents, sunscreens, surfactants, antioxidants, agents for preventing hair loss, antidandruff agents, propellants and ceramides, or mixtures thereof. Needless to say, a person skilled in the art will take care to select this or these optional additional compounds, and/or the amount thereof, such that the advantageous properties of the compositions according to the disclosure are not, or are not substantially, adversely affected by their addition.

The composition according to the disclosure may be in the form of a suspension, a dispersion, a solution (for example, an organic solution), a gel, an emulsion (for example, an oil-in-water (O/W); a water-in-oil (W/O) emulsion, or a multiple emulsion (W/O/W or polyol/O/W or O/W/O emulsion)), a cream, a paste, a mousse, a dispersion of vesicles, such as for example, dispersion of ionic or nonionic lipid vesicles), a two-phase or multi-phase lotion, a spray, a powder or a paste, including a soft paste, such as a paste having a dynamic viscosity at 25° C. of about from 0.1 to 40 Pa.s at a shear rate of 200 s⁻¹, after measurement for 10 minutes in cone/plate geometry. Further, the composition may be anhydrous in form, such as an anhydrous paste.

A person skilled in the art may select the appropriate form of the composition, as well as the method for preparing it, on the basis of his general knowledge, taking into account the nature of the constituents used, such as their solubility in the support, and the intended use of the composition.

The composition according to the disclosure may be a makeup composition, including a complexion product such as a foundation, a makeup rouge, or an eye shadow; a lip product, such as a lipstick or a lip care product; a concealer product; a blush, a mascara or an eyeliner; an eyebrow makeup product such as a lip or eye pencil; a nail product such as a nail varnish or a nail care product; a body makeup product; or a hair makeup product such as a hair mascara or hair lacquer.

The composition of the present disclosure may be a protective or care composition for facial skin, the neck, the hands or the body, such as an anti-wrinkle composition, an anti-fatigue composition for making the skin look radiant, a moisturizing or medicated composition, an sunscreen composition, or an artificial tanning composition.

The composition of the present disclosure may be a hair care product, i.e. for holding a hairstyle or for shaping the hair. The hair care product may be a shampoo, a hair setting gel or lotion, a blow-drying lotion, or a fixing and styling composition such as a lacquer or spray. The lotions may be packaged in various forms, including in vaporizers, pump-dispenser bottles, or aerosol containers to enable application of the composition in vaporized form or in the form of a mousse. Such packaging forms are advantageous when it is desired to obtain a spray or a mousse for fixing or treating the hair.

In a non-limiting embodiment the composition of the present disclosure is a makeup composition, such as a foundation or a lipstick.

Another aspect of the present disclosure is a cosmetic process for making up or caring for keratin materials, such as body or facial skin, the nails, the hair and/or the eyelashes, comprising providing the aforementioned composition, and applying the composition to a keratin material.

In a non-limiting embodiment, the present disclosure relates to a cosmetic process, comprising providing the aforementioned composition in the form of a cosmetic foundation or lipstick, and applying the composition to facial skin or the lips.

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches. Notwithstanding that the numerical ranges and parameters setting forth the broad scope of the invention are approximations, the numerical values set forth in the specific example are reported as precisely as possible. Any numerical value, however, inherently contains certain errors necessarily resulting from the standard deviation found in their respective testing measurements.

The following examples are intended to illustrate the invention in a non-limiting manner.

### EXAMPLE 1

### Preparation of a Gradient Copolymer of Poly(isobornyl acrylate)/methyl acrylate Composition

10 g of isododecane, 21 g of isobornyl acrylate, 9 g of methyl acrylate, 1.338 g of iodoperfluorohexane (3×10⁻³ mol) and 0.308 g of Perkadox SE-10 (9×10⁻⁴ mol) were introduced into a 250 ml three-necked flask. The mixture was stirred at 25° C. and, after dissolution, the three-necked flask was immersed in an oil bath thermostatically maintained at 80° C. After 1 hour 20 minutes at 80° C., a degree of conversion of 83% was observed.

A gradient copolymer of poly(isobornyl acrylate/methyl acrylate) composition was obtained, with an iodine atom at the end of each chain. The number-average molar mass (Mn) obtained was 8800 g/mol (theoretical Mn of 6500 g/mol).

The iodo end functions may be characterized by MALDI-TOF or by NMR.

### EXAMPLE 2

### Preparation of a Gradient Copolymer of Poly(isobornyl acrylate/methyl acrylate) Composition

10 g of isododecane, 24 g of isobornyl acrylate, 6 g of methyl acrylate, 1.339 g of iodoperfluorohexane (3×10⁻³ mol) and 0.308 g of Perkadox SE-10 (9×10⁻⁴ mol) were introduced into a 250 ml three-necked flask. The mixture was stirred at 25° C. and, after dissolution, the three-necked flask was immersed in an oil bath thermostatically maintained at 80° C. After 1 hour 40 minutes at 80° C., a degree of conversion of 81% was observed.

A linear and gradient copolymer of poly(isobornyl acrylate/methyl acrylate) composition was obtained, with an iodine atom at the end of each chain.

The number-average molar mass (Mn) obtained was 7650 g/mol (theoretical Mn of 6300 g/mol).

The iodo end functions may be characterized by MALDI-TOF or by NMR.

### EXAMPLE 3

### Preparation of a Gradient Copolymer of Poly(isobornyl acrylate/methyl acrylate) Composition

10 g of isododecane, 15 g of isobornyl acrylate, 15 g of methyl acrylate, 1.339 g of iodoperfluorohexane (3×10⁻³ mol) and 0.308 g of Perkadox SE-10 (9×10⁻⁴ mol) were introduced into a 250 ml three-necked flask. The mixture was stirred at 25° C. and, after dissolution, the three-necked flask was immersed in an oil bath thermostatically maintained at 75° C. After 1 hour 40 minutes at 75° C., a degree of conversion of 79% was observed.

A gradient copolymer of poly(isobornyl acrylate/methyl acrylate) composition was obtained, with an iodine atom at each chain end. The number-average molar mass (Mn) obtained was 9500 g/mol (theoretical Mn of 6100 g/mol).

The iodo end functions may be characterized by MALDI-TOF or by NMR.

### EXAMPLE 4

An anhydrous foundation was prepared, comprising (% by weight):

| | |
|---|---|
| polyethylene wax | 12% |
| volatile silicone oils | 25% |
| phenyltrimethicone | 20% |
| polymethyl methacrylate microspheres | 12% |
| polymer of Example 1 | 6% |
| isododecane | qs 100% |

Preparation:

The waxes were melted and, when everything was clear, the phenyl trimethicone was added with stirring, along with the silicone oils; the microspheres, the isododecane and the polymer were then added. The mixture was homogenized for 15 minutes and the resulting composition was cast and allowed to cool.

An anhydrous foundation was obtained.

### EXAMPLE 5

A nail varnish was prepared, comprising:
20% by weight of polymer according to Example 3
qs 100% of organic solvents (butyl acetate and ethyl acetate)

### EXAMPLE 6

A lipstick was prepared, comprising:

| | |
|---|---|
| polyethylene wax | 15% |
| polymer of Example 2 | 10% AM |
| hydrogenated polyisobutene (Parleam | 25% |
| from Nippon Oil Fats) | |
| pigments | 10% |
| isododecane | qs 100% |

The composition obtained after application to the lips had good cosmetic properties.

### EXAMPLE 7

### W/O Foundation

A foundation composition comprising the following compounds was prepared:

Phase A

| | | |
|---|---|---|
| cetyl dimethicone copolyol (Abil EM 90 | 3 | g |
| from Goldschmidt) | | |
| isostearyl diglyceryl succinate (Imwitor | 0.6 | g |
| 780 K from the company Condea) | | |
| isododecane | 18.5 | g |
| pigments (iron oxide and titanium oxide) | 10 | g |
| polymer of Example 1 | 8.7 | g ADM |
| polyamide powder (Nylon-12) | 8 | g |

| | |
|---|---|
| fragrance | qs |

Phase B

| | | |
|---|---|---|
| water | qs 100 | g |
| magnesium sulfate | 0.7 | g |

| | |
|---|---|
| preserving agent | qs |

ADM: active dry material

The composition obtained had good cosmetic properties.

1. A copolymer functionalized on at least one end with an iodine atom, and comprising at least two different monomers chosen from the following (meth)acrylic monomers and the salts thereof:
(i) (meth)acrylates of formula CH₂═CHCOOR or CH₂═C(CH₃)COOR wherein R is chosen from:
linear or branched alkyl groups containing from 1 to 30 carbon atoms optionally intercalated with at least one hetero atom chosen from O, N, S and P, and the alkyl group optionally substituted with at least one substituent chosen from —OH; halogen atoms chosen from Cl, Br, I and F; —NR₂R₃ groups, wherein R₂ and R₃, which may be identical or different, are chosen from hydrogen, a linear and branched C₁ to C₆ alkyl group and a phenyl group; and polyoxyalkylene groups consisting of 5 to 30 oxyalkylene units;
C₄ to C₁₂ cycloalkyl groups optionally comprising at least one heteroatom chosen from O, N, S and P, and optionally substituted with at least one substituent chosen from —OH and halogen atoms chosen from Cl, Br, I and F; and
C₄ to C₂₀ aryl or C₅ to C₃₀ aralkyl groups, wherein the alkyl group of the C₅ to C₃₀ aralkyl group contains from 1 to 8 carbon atoms;
(ii) (meth)acrylamides of formula CH₂═CHCONR₄R₅ or CH₂═C(CH₃)CONR₄R₅ wherein R₄ and R₅, which may be identical or different, are chosen from:
a hydrogen atom;
linear or branched alkyl groups containing from 1 to 18 carbon atoms, wherein the carbon atoms of the linear or branched alkyl groups are optionally intercalated with at least one heteroatom chosen from O, N, S and P; wherein the linear or branched alkyl groups are optionally substituted with at least one substituent chosen from hydroxyl groups, halogen atoms chosen from Cl, Br, I and F, and Si(R₆R₇) groups, wherein R₆ and R₇, which may be identical or different, are chosen from C₁ to C₆ alkyl groups and phenyl groups;
C₃ to C₁₂ cycloalkyl groups or heterocycloalkyl groups, wherein the heterocycloalkyl contains from 1 to 4 carbon atoms;
C₄ to C₂₀ aryl groups;
C₅ to C₃₀ aralkyl groups, wherein the alkyl group of the C₅ to C₃₀ aralkyl groups contains from 1 to 8 carbon atoms;
(iii) acrylic acid and methacrylic acid; and
(iv) carbon-based macromonomers containing at least one (meth)acrylate polymerizable end group.

2. The copolymer according to claim 1, wherein the copolymer is obtained by free-radical polymerization controlled by degenerative transfer at the iodine atom:
of a free-radical initiator,
of a transfer agent comprising at least one iodine atom, and
of the at least two different monomers chosen from the (meth)acrylic monomers and the salts thereof.

3. The copolymer according to claim 1, wherein at least one monomer is chosen from (meth)acrylates of formula CH₂═CHCOOR or CH₂═C(CH₃)COOR wherein R is chosen from polyoxyethylene and polyoxypropylene and the salts thereof.

4. The copolymer according to claim 1, wherein the C₃ to C₁₂ cycloalkyl groups or heterocycloalkyl groups are chosen from an isobornyl group, furfurylmethyl, tetrahydrofurfurylmethyl, and the salts thereof:

5. The copolymer according to claim 1, wherein the C₄ to C₂₀ aryl groups are chosen from a phenyl group and the salts thereof.

6. The copolymer according to claim 1, wherein the C₅ to C₃₀ aralkyl groups are chosen from 2-phenylethyl, t-butylbenzyl, and the salts thereof.

7. The copolymer according to claim 1, wherein the carbon-based macromonomer is chosen from the following monomers and the salts thereof:
linear or branched C₈-C₂₂ alkyl(meth)acrylate homopolymers and copolymers containing a (meth)acrylate polymerizable end group; and
polyolefins containing a (meth)acrylate end group.

8. The copolymer according to claim 1, wherein the (meth)acrylic monomers are chosen from at least one of the following monomers and the salts thereof:
methyl, ethyl, n-propyl, isopropyl, butyl, isobutyl, cyclohexyl, cyclodecyl, stearyl, behenyl, isobornyl and 2-ethylhexyl(meth)acrylates;
acrylic acid, methacrylic acid, N-ethyl(meth)acrylamide, N-butyl(meth)acrylamide, N-t-butyl(meth)acrylamide, N-isopropyl(meth)acrylamide, N,N-dimethyl(meth)acrylamide and N,N-dibutyl(meth)acrylamide;
linear or branched C₈-C₂₂ alkyl(meth)acrylate homopolymers and copolymers containing a polymerizable (meth)acrylate end group; and
polyolefins containing a (meth)acrylate end group.

9. The copolymer according to claim 1, wherein the (meth)acrylic monomers are chosen from at least one of the following monomers and the salts thereof:
isobornyl acrylate, isobornyl methacrylate, isobutyl acrylate, isobutyl methacrylate, 2-ethylhexyl acrylate, 2-ethylhexyl methacrylate, methyl acrylate, methyl methacrylate, stearyl acrylate, behenyl acrylate, acrylic acid and methacrylic acid; and
macromonomers of polyethylene/polypropylene copolymer containing a (meth)acrylate reactive end group and macromonomers of polyethylene/polybutylene copolymer containing a (meth)acrylate reactive end group.

10. The copolymer according to claim 1, wherein the (meth)acrylic monomers are present in an amount ranging from 30% to 100% by weight relative to the total weight of monomers.

11. The copolymer according to claim 10, wherein the (meth)acrylic monomers are present in an amount ranging from 70% to 95% by weight relative to the total weight of monomers

12. The copolymer according to claim 1, comprising a first monomer chosen from the (meth)acrylic monomers in an amount ranging from 1% to 99% by weight relative to the weight of the final copolymer, and a second monomer chosen from the (meth)acrylic monomers in an amount ranging from 1% to 99% by weight relative to the weight of the final copolymer.

13. The copolymer according to claim 12, comprising a first monomer chosen from the (meth)acrylic monomers in an amount ranging from 30% to 70% by weight relative to the weight of the final copolymer, and a second monomer chosen from the (meth)acrylic monomers in an amount ranging from 15% to 85% by weight relative to the weight of the final copolymer.

14. The copolymer according to claim 1, further comprising at least a third monomer chosen from the (meth)acrylic monomers and the salts thereof, present in a amount ranging from 1% to 50% by weight relative to the total weight of monomers.

15. The copolymer according to claim 14, wherein the third monomer chosen from the (meth)acrylic monomers and the salts thereof is present in an amount ranging from 4% to 35% by weight relative to the total weight of monomers.

16. The copolymer according to claim 1, further comprising at least one additional monomer chosen from an ethylenic monomer and the salts thereof, present in an amount ranging from 0.1% to 70% by weight relative to the total weight of the monomers.

17. The copolymer according to claim 16, wherein the at least one additional monomer is present in an amount ranging from 5% to 30% by weight relative to the total weight of the monomers.

18. The copolymer according to claim 16, wherein the at least one additional monomer is chosen from the following monomers and the salts thereof:
(i) ethylenically unsaturated monomers comprising at least one carboxylic, phosphoric or sulfonic acid or anhydride function and the salts thereof;
(ii) vinyl ethers of formula R₈O—CH═CH₂ and vinyl esters of formula R₈—COO—CH═CH₂,
wherein R₈ is chosen from linear and branched alkyl groups containing from 1 to 22 carbon atoms, a cyclic alkyl group containing from 3 to 6 carbon atoms, and an aromatic group,;
(iii) vinyl compounds of formulae: CH₂═CH—R₉, CH₂═CH—CH₂—R₉ and CH₂═C(CH₃)—CH₂—R₉,
wherein R₉ is chosen from
a hydroxyl;
halogens chosen from Cl and F;
NH₂;
OR₁₀ groups, wherein R₁₀ is chosen from a phenyl group and a C₁ to C₁₂ alkyl group, wherein the monomer is a vinyl or allylic ether;
acetamide (NHCOCH3);
OCOR₁₁ groups, wherein R₁₁ is chosen from linear and branched alkyl groups containing 2 to 12 carbon atoms, wherein the monomer is a vinyl or allylic ester;
linear or branched alkyl groups containing from 1 to 18 carbon atoms, wherein the carbon atoms of the linear or branched alkyl groups are optionally intercalated with at least one heteroatom chosen from O, N, S and P; wherein the linear or branched alkyl groups are optionally substituted with at least one substituent chosen from hydroxyl groups; halogen atoms chosen from Cl, Br, I and F; and Si(R₁₂R₁₃) groups, wherein R₁₂ and R₁₃, which may be identical or different, are chosen from C₁ to C₆ alkyl groups and phenyl groups;
C₃ to C₁₂ cycloalkyl groups;
C₃ to C₂₀ aryl groups;
C₄ to C₃₀ aralkyl groups, wherein the alkyl group of the aralkyl group contains from 1 to 8 carbon atoms;
4- to 12-membered heterocyclic groups containing at least one heteroatom chosen from O, N and S, wherein the ring of the hetercyclic group is aromatic or non-aromatic;
a heterocycloalkyl group wherein the hetercycloalkyl contains from 1 to 4 carbon atoms;
(iv) styrenes;
(v) ethylenically unsaturated monomers comprising one or more silicon atoms; and
(vi) carbon-based macromonomers containing at least-one polymerizable end group other than (meth)acrylic end groups, or silicone-based macromonomers containing at least one polymerizable end group.

19. The copolymer according to claim 16, wherein the at least one additional monomer is chosen from the following monomers and the salts thereof:
(i) linear or branched C₈-C₂₂ alkyl(meth)acrylate homopolymers and copolymers containing a polymerizable end group chosen from vinyl groups other than (meth)acrylate;
(ii) polyolefins containing an ethylenically unsaturated end group other than (meth)acrylate; and
(iii) polydimethylsiloxanes containing a mono(meth)acrylate end group.

20. The copolymer according to claim 19, wherein the at least one additional monomer is chosen from polydimethylsiloxanes containing a mono(meth)acrylate end group having the structure of formula (I) below: 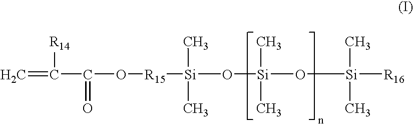
wherein:
R₁₄ is chosen from a hydrogen atom and methyl groups;
R₁₅ is chosen from linear and branched divalent hydrocarbon-based groups containing from 1 to 10 carbon atoms and optionally containing one or two ether bonds —O—;
R₁₆ is chosen from linear and branched alkyl groups containing from 1 to 10 carbon atoms;
n is an integer ranging from 1 to 300.

21. The copolymer according to claim 20, wherein n an integer ranging from 5 to 100.

22. The copolymer according to claim 16, wherein the at least one additional monomer is chosen from the following monomers and the salts thereof; ethylenically unsaturated monomers comprising one or more silicon atoms; styrenes; linear and branched C₈-C₂₂ alkyl(meth)acrylate homopolymers and copolymers containing a vinyl end group other than (meth)acrylate; polyolefins containing a vinyl end group other than (meth)acrylate, and polydimethylsiloxanes containing a mono(meth)acrylate end group.

23. The copolymer according to claim 1, comprising at least one monomer with a Tg of less than or equal to 20° C. and which is present in an amount ranging from 1% to 99% by weight relative to the total weight of the copolymer.

24. The copolymer according to claim 23, comprising at least one monomer with a Tg ranging from −120° C. and 15° C. and which is present in an amount ranging from 20% to 80% by weight relative to the total weight of the copolymer.

25. The copolymer according to claim 1, comprising at least one monomer with a Tg of greater than or equal to 20° C. and which is present in an amount ranging from 1% to 99% by weight relative to the total weight of the copolymer.

26. The copolymer according to claim 25, comprising at least one monomer with a Tg ranging from 40° C. and 140° C. and present in an amount ranging from 25% to 75% by weight relative to the total weight of the copolymer.

27. The copolymer according to claim 1, wherein the copolymer is soluble at a concentration of at least 1% by weight, in isododecane at 25° C. and 1 atm.

28. The copolymer according to claim 27, wherein the copolymer is soluble at a concentration of at least 10% by weight, in isododecane at 25° C. and 1 atm.

29. The copolymer according to claim 1, wherein the copolymer is in the form of block polymers or in the form of gradient polymers.

30. The copolymer according to claim 1, wherein the copolymer has a linear-chain, grafted or star structure.

31. The copolymer according to claim 1, wherein the copolymer has a number-average molecular mass ranging from 2000 g/mol to 1,000,000 g/mol.

32. The copolymer according to claim 31, wherein the copolymer has a number-average molecular mass ranging from 5000 g/mol to 50,000 g/mol.

33. The copolymer according to claim 2, wherein the polymerization initiator is chosen from azo-compounds,; peroxides; redox couples; peresters; percarbonates; persulfates; 2,5-bis(2-ethylhexanoylperoxy)-2,5-dimethylhexane; and tert-butyl peroxy-2-ethylhexanoate.

34. The copolymer according to claim 2, wherein the transfer agent is chosen from transfer agents of the formula R₁₇—I, in which R₁₇ is a linear, branched or cyclic, saturated or unsaturated alkyl radical containing from 1 to 30 carbon atoms and optionally comprising at least one substituent chosen from 1 to 4 additional iodine atoms, one or more fluorine atoms, and one or more functional groups chosen from CN and COOH.

35. The copolymer according to claim 34, wherein R₁₇ is chosen from an alkyl radical containing 1 to 6 carbon atoms, optionally comprising a substituent chosen from one or more halogen atoms and a CN function.

36. The copolymer according to claim 34, wherein the transfer agent is chosen from iodo-1-perfluorohexane, iodoacetonitrile (ICH₂—CN), iodo-1-methane, diiodomethane, iodoform or triiodomethane, iodo-1-perfluoroisopropane, diiodoperfluorohexane, iodo-1-phenylethane, iodo-1-propane, iodo-1-isopropane, iodo-1-phenyl, 1,4-diiodophenyl and iodo-1-tert-butane.

37. The copolymer according to claim 2, wherein the transfer agent is macromolecular and is in a form chosen from a polymer, a homopolymer and a copolymer, functionalized with at least one iodine atom.

38. A cosmetic comprising, in a physiologically acceptable medium, at least one copolymer functionalized on at least one end with an iodine atom, and comprising at least two different monomers chosen from the following (meth)acrylic monomers and the salts thereof:
(i) (meth)acrylates of formula CH₂═CHCOOR or CH₂═C(CH₃)COOR wherein R is chosen from:
linear or branched alkyl groups containing from 1 to 30 carbon atoms optionally intercalated with at least one hetero atom chosen from O, N, S and P, and the alkyl group optionally substituted with at least one substituent chosen from —OH; halogen atoms chosen from Cl, Br, I and F; —NR₂R₃ groups, wherein R₂ and R₃, which may be identical or different, are chosen from hydrogen, a linear and branched C₁ to C₆ alkyl group and a phenyl group; and polyoxyalkylene groups consisting of 5 to 30 oxyalkylene units;
C₄ to C₁₂ cycloalkyl groups optionally comprising at least one heteroatom chosen from O, N, S and P, and optionally substituted with at least one substituent chosen from —OH and halogen atoms chosen from Cl, Br, I and F; and
C₄ to C₂₀ aryl or C₅ to C₃₀ aralkyl groups, wherein the alkyl group of the C₅ to C₃₀ aralkyl group contains from 1 to 8 carbon atoms;
(ii) (meth)acrylamides of formula CH₂═CHCONR₄R₅ or CH₂═C(CH₃)CONR₄R₅ wherein R₄ and R₅, which may be identical or different, are chosen from:
a hydrogen atom;
linear or branched alkyl groups containing from 1 to 18 carbon atoms, wherein the carbon atoms of the linear or branched alkyl groups are optionally intercalated with at least one heteroatom chosen from O, N, S and P; wherein the linear or branched alkyl groups are optionally substituted with at least one substituent chosen from hydroxyl groups, halogen atoms chosen from Cl, Br, I and F, and Si(R₆R₇) groups, wherein R₆ and R₇, which may be identical or different, are chosen from C₁ to C₆ alkyl groups and phenyl groups;
C₃ to C₁₂ cycloalkyl groups or heterocycloalkyl groups, wherein the heterocycloalkyl contains from 1 to 4 carbon atoms;
C₄ to C₂₀ aryl groups;
C₅ to C₃₀ aralkyl groups, wherein the alkyl group of the C₅ to C₃₀ aralkyl groups contains from 1 to 8 carbon atoms;
(iii) acrylic acid and methacrylic acid; and
(iv) carbon-based macromonomers containing at least one (meth)acrylate polymerizable end group.

39. The composition according to claim 38, wherein the copolymer is present in an amount ranging from 0.1% to 95% by weight relative to the total weight of the composition.

40. The composition according to claim 38, wherein the copolymer is present in an amount ranging from 8% to 30% by weight relative to the total weight of the composition.

41. The composition according to claim 38, further comprising a fatty phase, optionally comprising oils and/or solvents having a global solubility parameter according to the Hansen solubility space of less than or equal to 20 (MPa)^{1/2}.

42. The composition according to claim 41, wherein the global solubility parameter according to the Hansen solubility space is less than or equal to 17 (MPa)^{1/2}.

43. The composition according to claim 38, further comprising at least one constituent chosen from:
volatile or non-volatile, natural or synthetic, carbon-based oils, hydrocarbon-based oils or fluoro oils, which are optionally branched;
ethers and esters containing more than 6 carbon atoms;
ketones containing more than 6 carbon atoms;
aliphatic fatty monoalcohols containing 6 to 30 carbon atoms, the hydrocarbon-based chain not comprising a substitution group.

44. The composition according to claim 43, comprising at least one oil chosen from carbon-based and hydrocarbon-based non-volatile oils of plant, mineral, animal or synthetic origin; linear, branched or cyclic esters containing more than 6 carbon atoms; esters derived from long-chain acids containing from 6 to 20 carbon atoms or alcohols containing from 6 to 20 carbon atoms; higher fatty acids; higher fatty alcohols; decanol; dodecanol; octadecanol; liquid triglycerides of fatty acids of 4 to 10 carbon atoms; linear or branched hydrocarbons of mineral or synthetic origin; synthetic esters and ethers; hydroxylated esters; polyol esters; pentaerythritol esters; fatty alcohols containing from 12 to 26 carbon atoms; ketones that are liquid at room temperature; propylene glycol ethers that are liquid at room temperature; short-chain esters containing from 3 to 8 carbon atoms in total; ethers that are liquid at room temperature; alkanes that are liquid at room temperature; cyclic aromatic compounds that are liquid at room temperature; aldehydes that are liquid at room temperature; non-silicone volatile oils.

45. The composition according to claim 43, comprising at least one constituent chosen from volatile or non-volatile alkanes that are liquid at room temperature.

46. The composition according to claim 45, wherein the volatile or non-volatile alkanes that are liquid at room temperature are chosen from decane, heptane, dodecane, isododecane, isohexadecane, cyclohexane and isodecane, and mixtures thereof.

47. The composition according to one of claim 44, wherein the oils and/or solvents are present in an amount ranging from 0.01% to 95% by weight relative to the total weight of the composition.

48. The composition according to one of claim 47, wherein the oils and/or solvents are present in an amount ranging from 30% to 80% by weight relative to the total weight of the composition.

49. The composition according to claim 38, further comprising at least one constituent chosen from water; alcohols; linear or branched lower monoalcohols containing from 2 to 5 carbon atoms; polyols; hydrophilic C₂ ethers and C₂-C₄ aldehydes; waxes; gums; dyestuffs chosen from water-soluble dyes, liposoluble dyes and pulverulent dyestuffs; fillers; additional polymers; film-forming polymers; vitamins; thickeners; gelling agents; trace elements; softeners; sequestering agents; fragrances; acidifying or basifying agents; preserving agents; sunscreens; surfactants; antioxidants; agents for preventing hair loss; antidandruff agents; propellants; and ceramides; and mixtures thereof.

50. The composition according to claim 49, wherein the linear or branched lower monoalcohols are chosen prom ethanol, isopropanol and n-propanol.

51. The composition according to claim 49, wherein the polyols are chosen from glycerol, diglycerol, propylene glycol, sorbitol, pentylene glycol and polyethylene glycols.

52. The composition according to claim 49, wherein the dyestuffs are chosen from pigments, nacres and flakes.

53. The composition according to claim 38, wherein the composition is in the form of a suspension, a dispersion, a solution, an organic solution, a gel, an emulsion, an oil-in-water (O/W), water-in-oil (W/O) emulsion, a multiple emulsion (W/O/W or polyol/O/W or O/W/O emulsion), a cream, a paste, a mousse, a dispersion of vesicles, a two-phase or multi-phase lotion, a spray, a powder or a paste.

54. The composition according to claim 53, wherein the composition is in the form of a disperson of ionic or non-ionic lipid vesicles.

55. The composition according to claim 53, wherein the composition is in the form of a soft, anhydrous paste.

56. The composition according to claim 38, wherein the composition is in the form of a complexion product chosen from a foundation, a makeup rouge and an eye shadow; a lip product chosen from a lipstick and a lipcare product; a concealer product; a blusher, a mascara or an eyeliner; an eyebrow makeup product; a lip or eye pencil; a nail product chosen from a nail varnish or a nailcare product; a body makeup product; a hair makeup product; a protective or care composition for facial skin, the neck, the hands or the body; an anti-wrinkle composition; an anti-fatigue composition for making the skin look radiant; a moisturizing or medicated composition; an antisun composition or an artifical tanning composition; and a haircare composition for holding the hairstyle or for shaping the hair.

57. The composition according to claim 38, wherein the composition is in the form of a makeup composition.

58. The composition of claim 38, wherein the composition is in the form of a foundation or a lipstick.

59. A process for making up or caring for keratin materials, comprising applying to the keratin materials a cosmetic composition comprising, in a physiologically acceptable medium, at least one copolymer functionalized on at least one end with an iodine atom, and comprising at least two different monomers chosen from the following (meth)acrylic monomers and the salts thereof:
(i) (meth)acrylates of formula CH₂═CHCOOR or CH₂═C(CH₃)COOR wherein R is chosen from:
linear or branched alkyl groups containing from 1 to 30 carbon atoms optionally intercalated with at least one hetero atom chosen from O, N, S and P, and the alkyl group optionally substituted with at least one substituent chosen from —OH; halogen atoms chosen from Cl, Br, I and F; —NR₂R₃ groups, wherein R₂ and R₃, which may be identical or different, are chosen from hydrogen, a linear and branched C₁ to C₆ alkyl group and a phenyl group; and polyoxyalkylene groups consisting of 5 to 30 oxyalkylene units;
C₄ to C₁₂ cycloalkyl groups optionally comprising at least one heteroatom chosen from O, N, S and P, and optionally substituted with at least one substituent chosen from —OH and halogen atoms chosen from Cl, Br, I and F; and
C₄ to C₂₀ aryl or C₅ to C₃₀ aralkyl groups, wherein the alkyl group of the C₅ to C₃₀ aralkyl group contains from 1 to 8 carbon atoms;
(ii) (meth)acrylamides of formula CH₂═CHCONR₄R₅ or CH₂═C(CH₃)CONR₄R₅ wherein R₄ and R₅, which may be identical or different, are chosen from:
a hydrogen atom;
linear or branched alkyl groups containing from 1 to 18 carbon atoms, wherein the carbon atoms of the linear or branched alkyl groups are optionally intercalated with at least one heteroatom chosen from O, N, S and P; wherein the linear or branched alkyl groups are optionally substituted with at least one substituent chosen from hydroxyl groups, halogen atoms chosen from Cl, Br, I and F, and Si(R₆R₇) groups, wherein R₆ and R₇, which may be identical or different, are chosen from C₁ to C₆ alkyl groups and phenyl groups;
C₃ to C₁₂ cycloalkyl groups or heterocycloalkyl groups, wherein the heterocycloalkyl contains from 1 to 4 carbon atoms;
C₄ to C₂₀ aryl groups;
C₅ to C₃₀ aralkyl groups, wherein the alkyl group of the C₅ to C₃₀ aralkyl groups contains from 1 to 8 carbon atoms;
(iii) acrylic acid and methacrylic acid; and
(iv) carbon-based macromonomers containing at least one (meth)acrylate polymerizable end group.

60. A process-for making up facial skin and/or the lips, comprising the application of a cosmetic foundation or lipstick composition comprising, in a physiologically acceptable medium, at least one copolymer functionalized on at least one end with an iodine atom, and comprising at least two different monomers chosen from the following (meth)acrylic monomers and the salts thereof:
(i) (meth)acrylates of formula CH₂═CHCOOR or CH₂═C(CH₃)COOR wherein R is chosen from:
linear or branched alkyl groups containing from 1 to 30 carbon atoms optionally intercalated with at least one hetero atom chosen from O, N, S and P, and the alkyl group optionally substituted with at least one substituent chosen from —OH; halogen atoms chosen from Cl, Br, I and F; —NR₂R₃ groups, wherein R₂ and R₃, which may be identical or different, are chosen from hydrogen, a linear and branched C₁ to C₆ alkyl group and a phenyl group; and polyoxyalkylene groups consisting of 5 to 30 oxyalkylene units;
C₄ to C₁₂ cycloalkyl groups optionally comprising at least one heteroatom chosen from O, N, S and P, and optionally substituted with at least one substituent chosen from —OH and halogen atoms chosen from Cl, Br, I and F; and
C₄ to C₂₀ aryl or C₅ to C₃₀ aralkyl groups, wherein the alkyl group of the C₅ to C₃₀ aralkyl group contains from 1 to 8 carbon atoms;
(ii) (meth)acrylamides of formula CH₂═CHCONR₄R₅ or CH₂═C(CH₃)CONR₄R₅ wherein R₄ and R₅, which may be identical or different, are chosen from:
a hydrogen atom;
linear or branched alkyl groups containing from 1 to 18 carbon atoms, wherein the carbon atoms of the linear or branched alkyl groups are optionally intercalated with at least one heteroatom chosen from O, N, S and P; wherein the linear or branched alkyl groups are optionally substituted with at least one substituent chosen from hydroxyl groups, halogen atoms chosen from Cl, Br, I and F, and Si(R₆R₇) groups, wherein R₆ and R₇, which may be identical or different, are chosen from C₁ to C₆ alkyl groups and phenyl groups;
C₃ to C₁₂ cycloalkyl groups or heterocycloalkyl groups, wherein the heterocycloalkyl contains from 1 to 4 carbon atoms;
C₄ to C₂₀ aryl groups;
C₅ to C₃₀ aralkyl groups, wherein the alkyl group of the C₅ to C₃₀ aralkyl groups contains from 1 to 8 carbon atoms;
(iii) acrylic acid and methacrylic acid; and
(iv) carbon-based macromonomers containing at least one (meth)acrylate polymerizable end group.
